(19) United States
(12) Patent Application Publication
(10) Pub. No.: US 2014/0115056 A1
(43) Pub. Date: Apr. 24, 2014

(54) BOOK THINNING

(71) Applicant: APPLE INC., Cupertino, CA (US)

(72) Inventors: David Makower, Cupertino, CA (US); Max M. Muller, III, San Jose, CA (US); Jason N. Gould, Belmont, CA (US); Martin J. Murrett, II, Portland, OR (US)

(73) Assignee: Apple Inc., Cupertino, CA (US)

(21) Appl. No.: 13/692,769

(22) Filed: Dec. 3, 2012

Related U.S. Application Data
(60) Provisional application No. 61/717,071, filed on Oct. 22, 2012.

(51) Int. Cl. H04L 29/06

(52) U.S. Cl. CPC H04L 65/403
USPC 709/204

(57) ABSTRACT

A system is configured to generate renditions of an electronic book. Different renditions of the electronic book contain the same collection of assets with at least one asset being a different quality. When the electronic book is requested by a client device, links to different renditions of the electronic book are provided. The client device can select a link and a rendition of the electronic book can be delivered to the client device.

### CROSS-REFERENCE TO RELATED APPLICATIONS

The present application claims priority to provisional U.S. Patent Application No. 61/717,071 titled “Book Thinning,” filed Oct. 22, 2012, the disclosures of which are expressly incorporated therein by reference in their entireties.

### BACKGROUND

1. Technical Field

The present disclosure relates generally to the distribution of digital media items and more specifically to the generation of different renditions of a digital media item and the distribution of the different renditions to a client device.

2. Introduction

With the growth of the Internet, electronic commerce has become a powerful tool to purchase and sell products. This is particularly true for digital media. By utilizing a browser, a customer using a client device can access an online digital media store to browse through and purchase digital assets. Digital assets can include media items such as music, movies, audiobooks, and electronic books. Digital assets can also include software applications. Digital assets sold through the online store can be subsequently downloaded to the client device. Once downloaded, digital assets such as media items can be played back on the client device by using a media player application and digital assets such as software applications can be installed on the client device.

Different client devices can have different hardware configurations. As a result, a digital asset configured for one client device may not perform well on a different client device. For example, a newer model of a client device can have a higher resolution screen, improved sound (through a higher bit rate), more memory, or a faster processor. Digital assets optimized for these newer models may be larger in size than a digital asset optimized for an older model since more information is required to present the digital asset with higher resolution or improved sound. As a result, digital assets that are optimized for one model of a client device may not be optimized for another model of the client device. This can create performance issues. For example, a media item optimized for an older model of the client device does not take advantage of the capabilities available on the newer model of the client device. Moreover, a media item that is not optimized for a model of the client device may need to be converted into a different format supported by the client device. As another example, a media item created for a newer model of the client device but is played on an older model of the client device can result in the older client device not fully utilizing the information available in the media item. For instance, a media item that is generated for a high resolution display is not fully utilized by a client device having a low resolution display since the low resolution display is unable to process all of the image information available. As a result, some of the information from the high resolution digital asset is received from the online store but not utilized by the client device. Thus, there is a need for improved techniques to deliver digital assets to a client device.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present disclosure addresses the need in the art for systems, devices, techniques, and methods for the distribution of digital assets. Digital assets can include media items (e.g., images, audio books, electronic books (eBooks), music, videos, movies, and other types of digital media) and software applications that can be executed by a processor of a client device. In some examples, a digital asset can be a combination of other digital assets. For example, eBooks can include text along with a composite of images and videos. In order to accommodate different client needs and different client devices, different renditions of a digital asset can be generated and a desired rendition can be provided to a client device. Depending on the hardware and software configuration of a client device, images and video having a specific format or size can be preferred. As a result, a distribution center can generate different renditions or flavors of an eBook for distribution. Each rendition of the eBook can include the same or similar content (e.g., text, images, and videos) and layout but different sizes or quality. For example, one rendition can include an image having a resolution or pixels per inch. A second rendition can have the same image but with a different resolution or pixels per inch.

When an eBook is purchased by a client, a rendition of the eBook can provided to the client. Depending on implementation details, the rendition can be selected by the client or the distribution center. In one embodiment, a rendition of an eBook can be selected over the other renditions based on the hardware configuration of the client device. For example, a low resolution rendition can be preferred for a device having a low resolution display since some of the information in the high resolution rendition would not be able to be presented on the low resolution display. As stated above, the low resolution rendition and the high resolution rendition can include the same or similar composite of assets (e.g., text, images, videos, etc.) but in a different format, quality, or size. In one embodiment, one rendition of the eBook can be selected based on the software configuration of the client device. For example, a media playback application running on the client device can require videos in the eBook to be in a specific format or have a specific encoding. In other embodiments, an eBook rendition can be selected based on system constraints. For example, an eBook rendition can be selected according to the bandwidth available between a client device and a distribution center. During periods of low bandwidth, an eBook rendition having a reduced size can be selected. During periods of high bandwidth, a larger sized eBook rendition can be provided to the client device. In some scenarios, the client may re-download the eBook to the same client device or to a different client device. During the re-download process, the same or different rendition of the eBook can be delivered.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system for generating renditions of eBooks;

FIG. 2 illustrates an exemplary system for distributing eBooks;

FIG. 3a illustrates an exemplary system for distributing eBooks;

FIG. 3b illustrates another exemplary communication session for distributing eBooks;

FIG. 3c illustrates another exemplary communication session for distributing eBooks;

FIG. 4 illustrates an exemplary method for generating a rendition of an eBook;

FIG. 5 illustrates an exemplary process for distributing a rendition of an eBook;

FIG. 6 illustrates an exemplary process for executing a sync request between two client devices;

FIG. 7 illustrates an exemplary system; and

FIG. 8 illustrates an exemplary cloud system.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for systems, devices, techniques, and methods for the distribution of digital assets. Digital assets can include media items (e.g., images, audio books, electronic books (eBooks), music, videos, movies, and other types of digital media) and software applications that can be executed by a processor of a client device. In some examples, a digital asset can be a combination of other digital assets. For example, eBooks can include text along with a composite of images and videos. In order to accommodate client needs and different client devices, different renditions of a digital asset can be generated and a desired rendition can be provided to a client device. While the remainder of the detailed description focuses on eBooks as one exemplary digital asset, it is to be understood by one of ordinary skill in the art that the techniques and methods described herein are also applicable to other types of digital assets.

A system and device is configured to provide a rendition of an eBook to a client device after the client purchases the eBook. Depending on implementation details, the rendition can be selected by the client or the distribution center. In one example, a rendition of an eBook can be selected based on the hardware configuration of the client device. As stated above, a first rendition and the second rendition can include the same or similar composite of assets (e.g., text, images, videos, etc.) but in a different format, quality, or size. A rendition of the eBook can be selected based on the software configuration of the client device. For example, a media playback application running on the client device configured for a specific format or encoding can select a rendition of the eBook in the specified format or encoding. In some examples, an eBook rendition can be selected based on system constraints. For example, an eBook rendition can be selected according to the bandwidth available between a client device and a distribution center. During period of low bandwidth, an eBook rendition having a reduced size can be selected. During periods of high bandwidth, a larger sized eBook rendition can be provided to the client device. In some scenarios, the client may re-download the eBook to the same client device or to a different client device. During the re-download process, the same or different rendition of the eBook can be delivered. A detailed discussion of the methods and systems surrounding the concept of generating and distributing different renditions of a digital asset are disclosed below.

Generating Renditions of eBooks

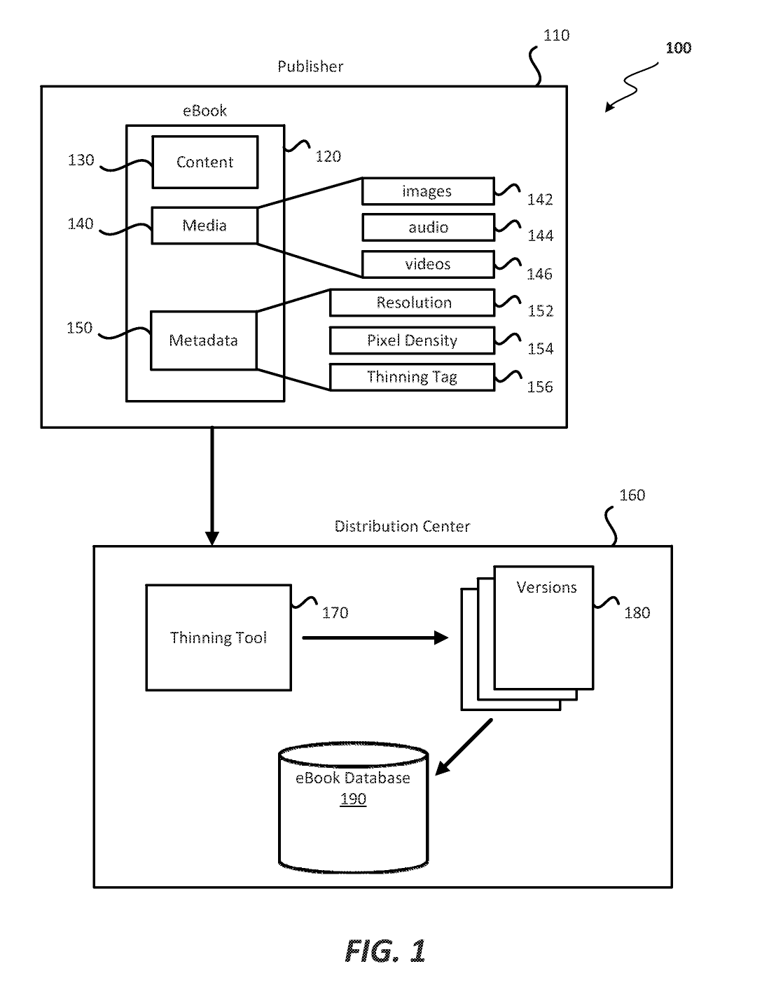

FIG. 1 illustrates an exemplary system for generating renditions of eBooks. In other examples, system 100 can be configured to generate other types of digital assets, including media items and software. System 100 includes publisher 110 and distribution center 160. Publisher 110 can be configured to author eBooks to be distributed by distribution center 160. Distribution center 160 includes thinning tool 170 that is configured to generate different renditions or flavors of an eBook. As shown here, publisher 110 authors eBook 120. eBook 120 can include content 130, media 140, and metadata 150. Content 130 consists of text while media 140 includes images 142, audio 144, and videos 146. eBook 120 can also include instructions for presenting content 130 and media 140 together on the pages of eBook 120.

eBook 120 can also include metadata 150. Metadata 150 can include a manifest containing properties and attributes of eBook 120. For example, metadata 150 can include thinning tag 156 configured to notify distribution center 160 whether eBook 120 has been thinned. The manifest can also extend to the properties and attributes of the collection of elements and assets that make up eBook 120, such as the properties of an image or a video of eBook 120. For example, metadata describing the resolution or pixel density of an image can be stored. The manifest can also store properties that are unrelated to the eBook, such as the desired resolution 152 or pixel density 154. The desired resolution 152 can be one or more resolution values that describe the resolution of the display related to different client devices supported by system 100. The desired pixel density 154 can be one or more pixel density values for different renditions of the eBook. Other examples can store other hardware or software configurations of client devices supported by system 100. In one embodiment, publisher 110 can define the different renditions of eBook 120 that the publisher would like to create by setting metadata 150. In other words, each rendition can store information of the existence other renditions of the eBook. The other renditions can be specified by the publisher, the distribution center, or the client themselves.

Publisher 110 can be configured to communicate with distribution center 160. In one embodiment, an authored eBook 120 can be delivered to distribution center 160. Distribution center 160 can process the eBook and store the processed eBook in eBook database 190. Processing eBook 120 can include performing a series of checks that prepare the eBook for storage and distribution. In one embodiment, the processing can also include thinning tool 170. Thinning tool 170 is configured to create one or more renditions of eBook 120. Thinning tool 170 can edit the content and/or media of the eBook through resampling, resizing, compressing, extrapolating, and other processing techniques to create a rendition of the eBook that is a different size. In one example, the created rendition can include content and/or media that are at a different resolution or pixel density than the original. This can result in an eBook file that is a different size that takes up a different footprint in storage. Depending on the parameters used in creating the new rendition, a larger file or smaller file (that is a higher or lower quality eBook) can be generated. eBook 120 can also be stored as a rendition of the eBook.

Thinning tool 170 can receive eBook 120 and determine whether one or more renditions of eBook 120 should be created. In one embodiment, thinning tool 170 can evaluate an attribute of metadata 150 to determine whether a new rendition should be created. For example, thinning tag 156 of metadata 150 can be used to determine whether a rendition of the eBook 120 is to be created by thinning tool 170. As another example, resolution 152 can store the resolution of displays belonging to client devices which publisher 110 would like to support. Based on the values stored in resolution 152, different renditions of eBook 120 can be created. As another example, pixel density 154 can store the pixel densities for different renditions of the eBook that publisher 110 would like to have created.

If a rendition is to be created, thinning tool 170 can create the one or more renditions according to parameters stored in distribution center 160 and/or metadata 150. In one embodiment, thinning tool 170 can evaluate parameters stored in distribution 160 to determine the different renditions of eBook 120 that are to be created. Based on metadata 150, thinning tool 170 can determine if eBook 120 is one of the specified renditions and generate eBooks for the remaining renditions. In one embodiment, metadata 150 of eBook 120 can include parameters for creating different renditions of the eBook. Different renditions of an eBook can have the same or similar composite of assets but in different size, resolution, and/or quality. In some examples, an asset can be removed from the rendition of the eBook and replaced with a link to fetch the asset from a remote location. When the asset is requested by a media player application (i.e., the reader flips to the page of the eBook containing the asset or the page before the page of the eBook containing the asset), the media player application can follow the link and download the asset. Once downloaded, the asset can be presented to the reader. This can result in a rendition of the eBook that is reduced in size. eBooks that are reduced in size can be quickly provided to a client device and can also take up a smaller footprint in the storage available on the client device. Media in the eBook can be provided to the client device upon request. When processing is completed, thinning tool 170 generates renditions 180. Renditions 180 and eBook 120 can be stored in eBook database 190 where they can be retrieved for distribution at a later point in time. While the thinning tool is described here as a tool for reducing the size of an eBook, the thinning tool can also be used to create a high quality (e.g., high resolution.) rendition of an eBook from a low quality rendition. For example, low resolution images from a rendition of the eBook can be upsized and resampled to create high resolution images for another rendition of the eBook.

Distributing eBooks

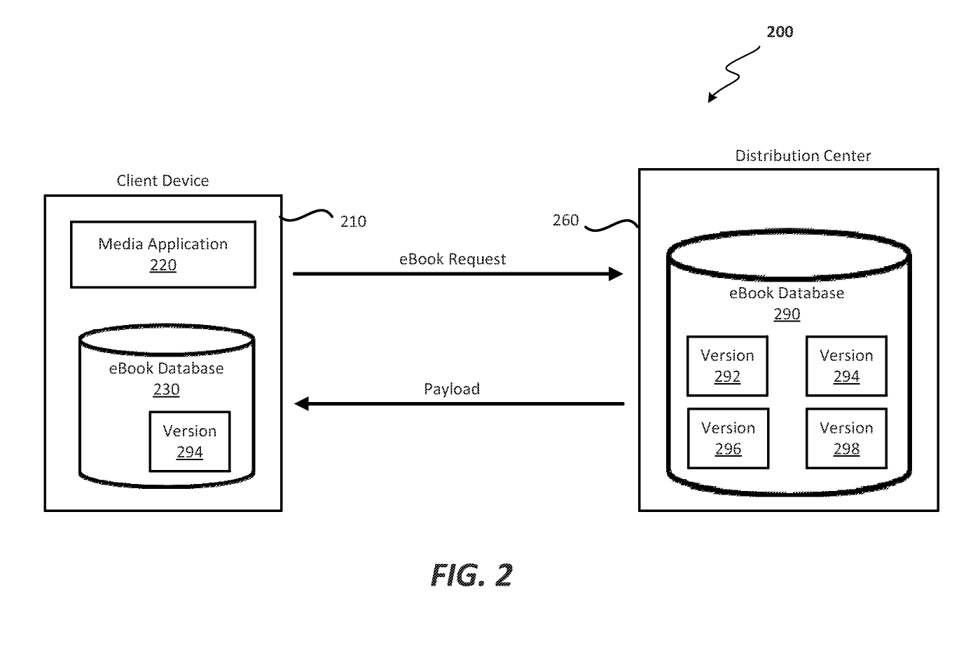

FIG. 2 illustrates an exemplary system for distributing eBooks. System 200 includes client device 210 and distribution center 250. In some examples, distribution center 250 can be similar or substantially similar to distribution center 160 of FIG. 1. Distribution center 260 can include eBook database 290, which in some examples can be similar or substantially similar to eBook database 190 of FIG. 1. eBook database 290 includes four renditions of an eBook: rendition 292, rendition 294, rendition 296, and rendition 298. Each rendition can be similar or substantially similar to eBook 120 of FIG. 1. In some examples, fewer or more renditions of an eBook can be stored in eBook database 290. In other examples, each rendition can include metadata that identifies other available renditions.

Distribution center 260 can communicate with client device 210. Client device 210 includes media application 220 that is configured to process an eBook from eBook database 230 for presentation to a reader. In one embodiment, client device 210 can request an eBook from distribution center 260. The request can be to purchase an eBook. Alternatively, the request can be to download an eBook that the client has previously purchased or otherwise has rights to download. Distribution 260 can process the request via a processor and determine that multiple renditions of the eBook are available in eBook database 290. In one embodiment, each rendition of the eBook can be delivered, transmitted, or otherwise provided to client device 210 as part of the payload, which in turn can store the renditions in eBook database 230. In one embodiment, a processor can generate a unique link for each rendition of the eBook. Each link can be configured to download a rendition of the eBook. For example, one link can be configured to download a high resolution rendition of the eBook while another link can be configured to download a low resolution rendition of the eBook. The distribution center 260 can provide the links to client device 210 as part of the payload. Each link can be accompanied with metadata describing the rendition of the eBook that is associated with the link. Client device 210 can evaluate the payload and select a link from the links provided. The selection can be communicated to distribution center 260 or a fulfillment server capable of providing the rendition of the eBook that is associated with the selected link to client device 210.

Here, client device 210 has selected rendition 294. As a result, rendition 294 is delivered to client device 210 (either directly in the payload or indirectly via a link) and is stored in eBook database 230. In some scenarios, distribution center 260 can provide multiple renditions of an eBook simultaneously to the client device. For example, more than one rendition of the eBook can be provided when distribution center 260 determines that client device 210 is a hub for distributing eBooks to multiple client devices. For instance, a client computer can be a hub for multiple portable devices that belong to the client. Alternatively, client device 210 can also select multiple links, thereby downloading multiple renditions of the eBook. The different renditions can be stored on eBook database 230 and subsequently synced to another client device or provided to another client device.

Syncing eBooks

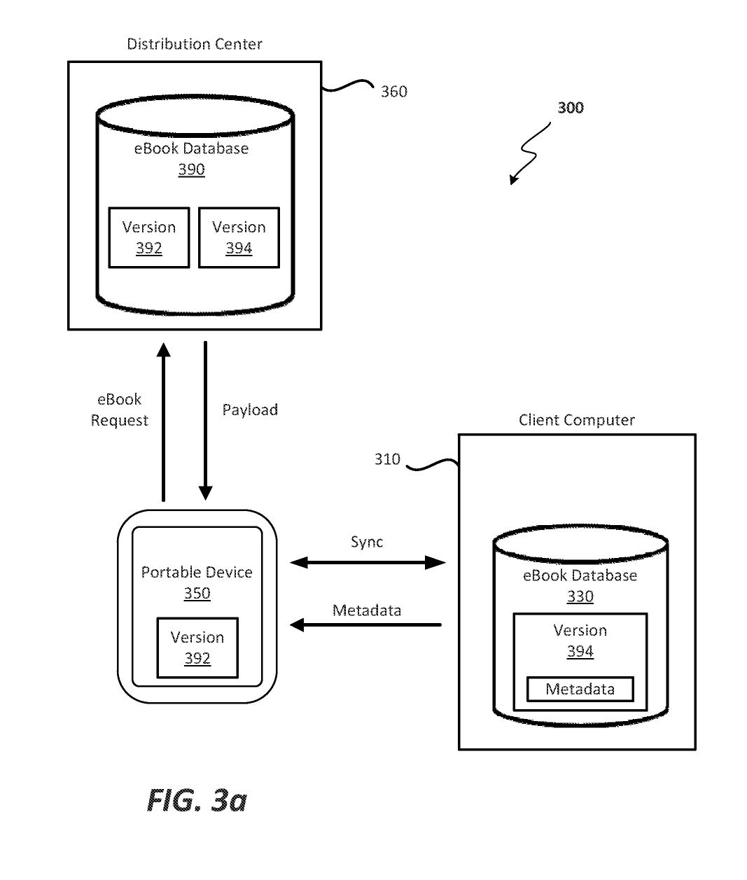

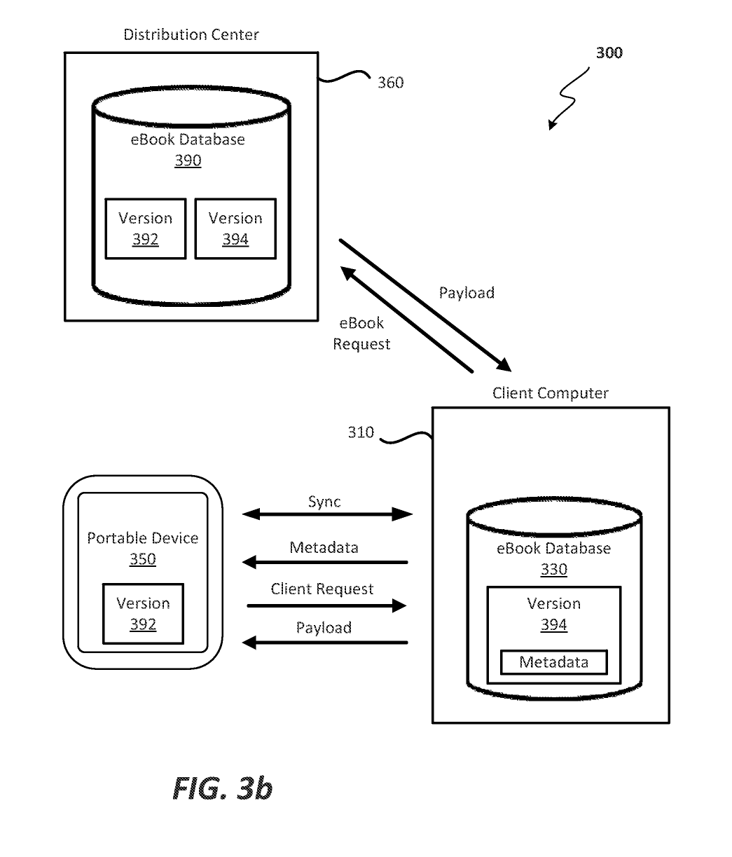

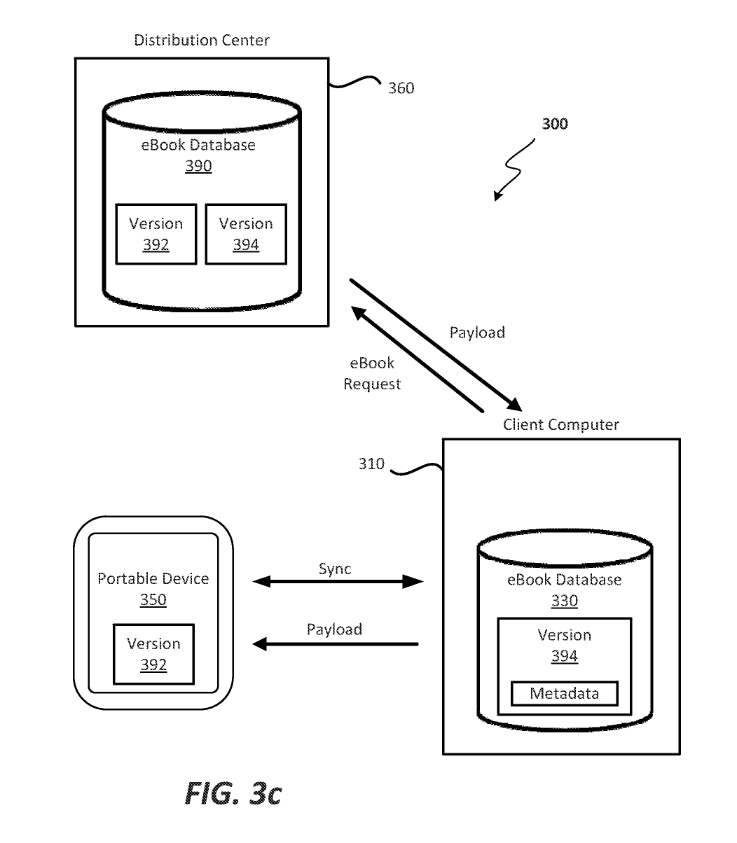

FIG. 3a illustrates an exemplary system for distributing eBooks. System 300 includes distribution center 360, client computer 310, and portable device 350. An exemplary communication session is shown between the three devices. In some examples, distribution center 360 can be similar or substantially similar to distribution center 260 of FIG. 2 or distribution center 160 of FIG. 1. In some examples, client computer 310 and portable device 350 can be similar or substantially similar to client device 210 of FIG. 2. Client computer 310 and portable device 350 can both be associated with a single client. In one example, client computer 310 can be a client device configured to store the client's media library while portable device 350 can be a lightweight portable client device capable of storing a portion of the client's media library. Portable device 350 can communicate with client computer 310 to periodically sync with client computer 310. During syncing, newly acquired assets stored on portable device 350 can be downloaded to client computer 310. Syncing can also allow portable device 350 to download assets from the user's media library stored on client computer 310.

Portable device 350 can also communicate with distribution center 360. In one embodiment, portable device 350 can directly communicate with distribution center 360 to request a rendition of an eBook that is not available on client computer 310 during syncing. Here, a sync request between portable device 350 and client computer 310 can include a request to provide an eBook to portable device 350. In response to the sync request, client computer 210 can provide metadata to the portable device. The metadata can be related to the eBook rendition(s) available on client computer 310 for syncing with portable device 350. The metadata can also include information regarding eBook rendition(s) that exist but are unavailable on client computer 310. In other words, the metadata can identify all renditions of the eBook and/or identify the rendition(s) that are available on client computer 310. In one example, the metadata can include the resolution of a display for which the eBook rendition has been optimized for. In another example, the metadata can include an attribute of a video in the eBook, such as the encoding, the bitrate, and the resolution of the video. In yet another example, the metadata can include a thinning tag that when flagged, identifies the rendition of the eBook as a rendition that has been reduced in size. Portable device 350 can evaluate the metadata and respond with a selection of an eBook rendition. In one scenario, the selected eBook rendition is available on client computer 310. In this scenario, the eBook rendition is delivered to portable device 350. In another scenario, the selected eBook rendition is not available on client computer 310. In this scenario, portable device 350 can transmit an eBook request to distribution center 360 for the eBook rendition. In response to the request, distribution center 360 can provide portable device 350 with a payload. The payload can be the requested eBook rendition or a link to download the requested eBook rendition.

Here, eBook database 330 stores rendition 394 of the eBook. During a sync request, portable device 350 requests the eBook from client computer 310. In response, client computer 310 transmits metadata to portable device 350. The metadata can identify the rendition that is available on client computer 310 and optionally renditions that are available from other sources, locally or remote. The metadata can be stored locally on one or more renditions of the eBook available on client computer 310. In one embodiment, the metadata can be transmitted to portable device 350 before delivery of the digital asset (e.g., rendition of eBook). This can improve the use of available bandwidth between client computer 310 and portable device 350 since a rendition of the eBook is transmitted to portable device 350 after a selected rendition has been identified. As a result, available bandwidth is not spent transmitting unselected eBook renditions. Portable device 350 evaluates the metadata and in response, selects rendition 292 of the eBook, which is unavailable on client computer 310. As a result, portable device 350 requests rendition 392 from distribution center 360. In response, distribution center 360 provides a payload, which results in rendition 392 being stored in portable device 350. In other examples, portable device 350 can prefer to download renditions of the eBook directly from distribution center 360 for privacy or security reasons.

FIG. 3b illustrates another exemplary communication session for distributing eBooks. System 300 includes distribution center 360, client computer 310, and portable device 350. In some examples, distribution center 360 can be similar or substantially similar to distribution center 260 of FIG. 2 or distribution center 160 of FIG. 1. In some examples, client computer 310 and portable device 350 can be similar or substantially similar to client device 210 of FIG. 2. Client computer 310 and portable device 350 can both be associated with the same client. In one example, client computer 310 can be a client device configured to store the client's media library while portable device 350 can be a lightweight portable client device capable of storing a portion of the client's media library. Portable device 350 can communicate with client computer 310 to periodically sync with client computer 310. During syncing, newly acquired assets stored on portable device 350 can be downloaded to client computer 310. Syncing can also allow portable device 350 to download material from the user's media library stored on client computer 310.

As shown, portable device 350 syncs with client computer 310. During syncing, client computer 310 can transmit metadata related to the eBook to portable device 350. The metadata can be configured to identify the renditions of the eBook that are available, both on client computer 310 and distribution center 360. The metadata can also be configured to identify properties of those renditions, such as the resolution of the display that the rendition has been optimized for, processor requirements, memory requirements, player constraints, or other parameters related to the rendition or a client device that is to playback the rendition. In response to the metadata, portable device 350 can transmit a client request to client computer 310. The client request can include a request for a rendition of the eBook selected by the client. Client computer 310 can process the client request by delivering the selected rendition to portable device 350. Here, the selected rendition 392 is unavailable on client computer 310. As a result, client computer 310 can transmit an eBook request to distribution center 360 to request rendition 394. eBook database 360 can process the request and transmit the payload to client computer 310, which in turn relays rendition 392 to portable device 350. In one example, client computer 310 can save rendition 392 in eBook database 330. The communication session illustrated in FIG. 3b can be preferred in some scenarios, particularly scenarios where portable device 350 is unable to communicate with eBook database 390. For example, portable device 350 can lack a wireless communication channel that would allow it to communicate with a remote source. As a result, client computer 310 can retrieve the selected rendition and then deliver the selected rendition to portable device 350 through a wired communication channel such as a data cable. In other examples, other requests from portable device 350 can be routed through client compute 310 and fulfilled by distribution center 360.

FIG. 3c illustrates another exemplary communication session for distributing eBooks. System 300 includes distribution center 360, client computer 310, and portable device 350. In some examples, distribution center 360 can be similar or substantially similar to distribution center 260 of FIG. 2 or distribution center 160 of FIG. 1. In some examples, client computer 310 and portable device 350 can be similar or substantially similar to client device 210 of FIG. 2. Client computer 310 and portable device 350 can both be associated with a single client. In one example, client computer 310 can be a client device configured to store the client's media library while portable device 350 can be a lightweight portable client device capable of storing a portion of the client's media library. Portable device 350 can communicate with client computer 310 to periodically sync with client computer 310. During syncing, newly acquired assets stored on portable device 350 can be downloaded to client computer 310. Syncing can also allow portable device 350 to download material from the user's media library stored on client computer 310.

As shown here, FIG. 3c illustrates a communication session that minimizes communication between portable device 350 and client computer 310. Here, portable device 350 syncs with client computer 310. During syncing, portable device 350 can request an eBook from client computer 310. The request can also include parameters (such as hardware or software parameters) of portable device 350 that can be used by client computer 310 to identify a rendition of the eBook for portable device 350. In one example, client computer 310 determines the available renditions by examining the metadata of rendition 294 and then selects a rendition from the available renditions according to the parameters of portable device 350. Once the rendition has been selected, client computer 310 can provide a payload including the selected rendition of the eBook to portable device 350. If the identified rendition is not available on client computer 310, client computer 310 can communicate with distribution center 360 to download the selected rendition. In some scenarios, the exemplary communication session illustrated in FIG. 3c can be preferred when the client operating portable device 350 does not want to manually select a rendition of the eBook. Client computer 310 includes heuristics and logic capable of selecting a rendition of the eBook based on metadata of a rendition of the eBook stored in eBook database 330 and hardware or software parameters of portable device 350.

In some examples, system 300 can be configured to perform one or more of the communication sessions illustrated in FIGS. 3a, 3b, and 3c. For example, a setting on portable device 350 can be configured to adjust how much control a client would like to have during the sync process. If the client would like more automated approach to the syncing process, a communication session as illustrated in FIG. 3c can be selected. If the client would like additional control by manually selecting a rendition of the eBook, communication session as illustrated in FIG. 3a or 3b can be selected. In other examples, system 300 can select a communication session according to the current status of client computer 310 and/or portable device 350. For example, a communication session that does not require client computer 310 to communicate with distribution center 360 can be selected when the current status of client computer 310 reports that the communication channel between distribution center 360 and client computer 310 is busy or unavailable. Similarly, a communication session that does not require portable device 350 to communicate with distribution center 360 can be selected when the current status of client computer 310 reports that the communication channel between distribution center 360 and portable device is busy or unavailable. In yet another example, system 300 can select one of portable device 350 and client computer 310 to communicate with distribution center 360 based on the available bandwidth between the communication channel of these two client devices. The client device with more available bandwidth to communicate with distribution center 360 can be selected as the device to download renditions of the eBook from distribution center 360.

### Exemplary Methods

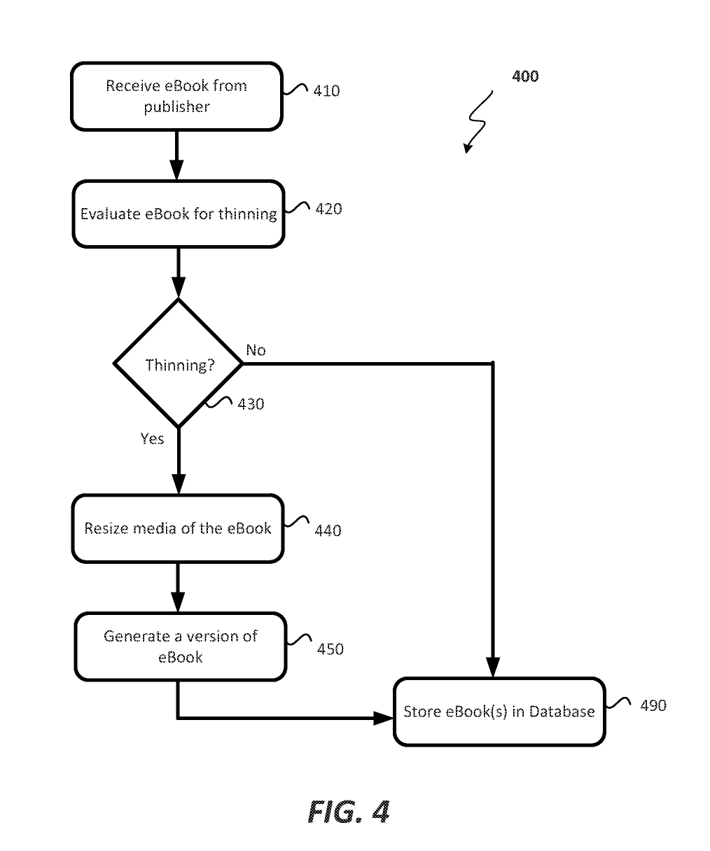

FIG. 4 illustrates an exemplary method for generating a rendition of an eBook. Process 400 can be stored in computer readable media and be executed by a processor. The processor can be part of a distribution center or alternatively a client device. This can allow different renditions of the eBook to be generated by a distribution center or a client device. A client device can be configured to serve as a hub to distribute eBooks to other client devices.

Process 400 can begin by receiving an eBook from a publisher at 410. The eBook received can be a rendition of the eBook that was authored by the publisher and provided to a distribution center. After receiving the eBook, an evaluation can be performed on the eBook to determine whether the eBook should be thinned at 420. The evaluation can include examining metadata of the eBook. As an example, a publisher can generate a low resolution rendition of the eBook. The low resolution rendition of the eBook can include metadata that identifies the rendition as the low resolution rendition. When the eBook is evaluated, a determination can be made that the eBook does not need to be thinned since it is already a low resolution rendition. The evaluation can also include examining variables and parameters stored at the distribution center. For example, the distribution center can include a list of renditions that are to be generated for each eBook. The eBook received by the publisher can represent one of these renditions, thus creating a subset list of renditions that need to be generated.

After the eBook is evaluated a decision is made at 430 to decide whether thinning should be performed on the eBook. If the eBook does not need to be thinned the eBook received from the publisher is stored in a database at 490. Alternatively if thinning is desired, media of the eBook can be resized to a desired quality at 440. Resizing can include using a variety of image processing or video processing techniques to change the quality, resolution, formatting, or size of the media. The resized images, text, or videos can be used to generate a rendition of the eBook at step 450. Once the new rendition is generated, the eBook received by the publisher (e.g., one rendition of the eBook) and/or the generated rendition can be stored in a database at 490.

Although process 400 has been described as a method to generate renditions of the eBook that are reduced in size, one of ordinary skill in the art would understand that a similar process can be applied to generate renditions of the eBook that are larger in size. For example, images in the eBook can be enlarged using a similar process as that shown in FIG. 4.

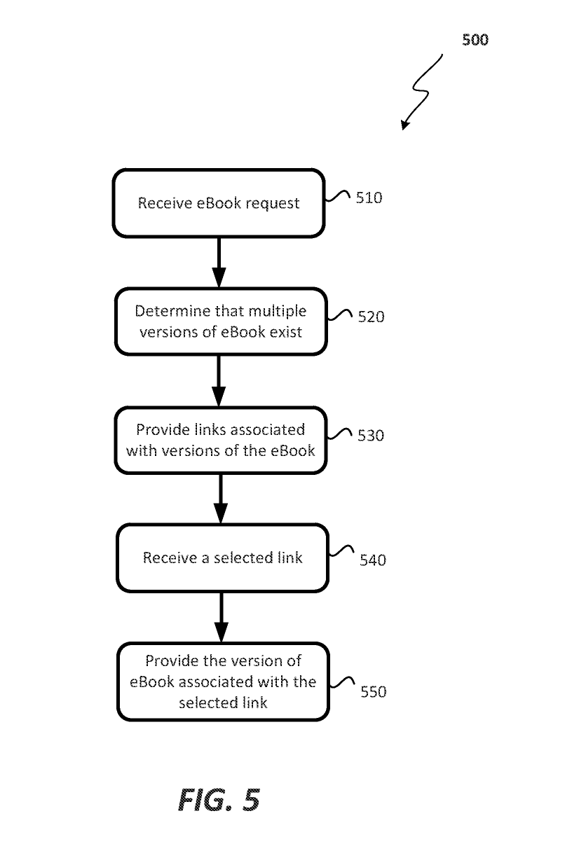

FIG. 5 illustrates an exemplary process for distributing a rendition of an eBook. Process 500 can be stored in computer readable media and be executed by a processor. The processor can be part of a device configured to distribute renditions of an eBook to a client device. In one example, the device can be a distribution center on the server side. In another example, the device can be a client device capable of distributing renditions of eBooks to other client devices. For instance, the client device can be a desktop computer configured to serve as a hub such to distribute eBooks to other client devices. Some of the other client devices can be portable.

Process 500 begins by receiving an eBook request at 510. The request can include an identifier associated with the requested eBook. The identifier can be queried in an eBook database to determine that multiple renditions of the eBook exist at 520. Links associated with the multiple renditions of the eBook can be provided to the requester at 530. Each rendition available can have a dedicated link that is provided to the requester. In one example, the dedicated link can be stored as metadata on the rendition. In another example, the dedicated link can be generated dynamically during run time. After providing the links to the requester, a selected link can be received at 540. The selected link can be processed and the rendition of the eBook associated with the selected link can be provided to the requester at 550. In other examples, the process described above can be performed in a different order, with more or fewer instructions.

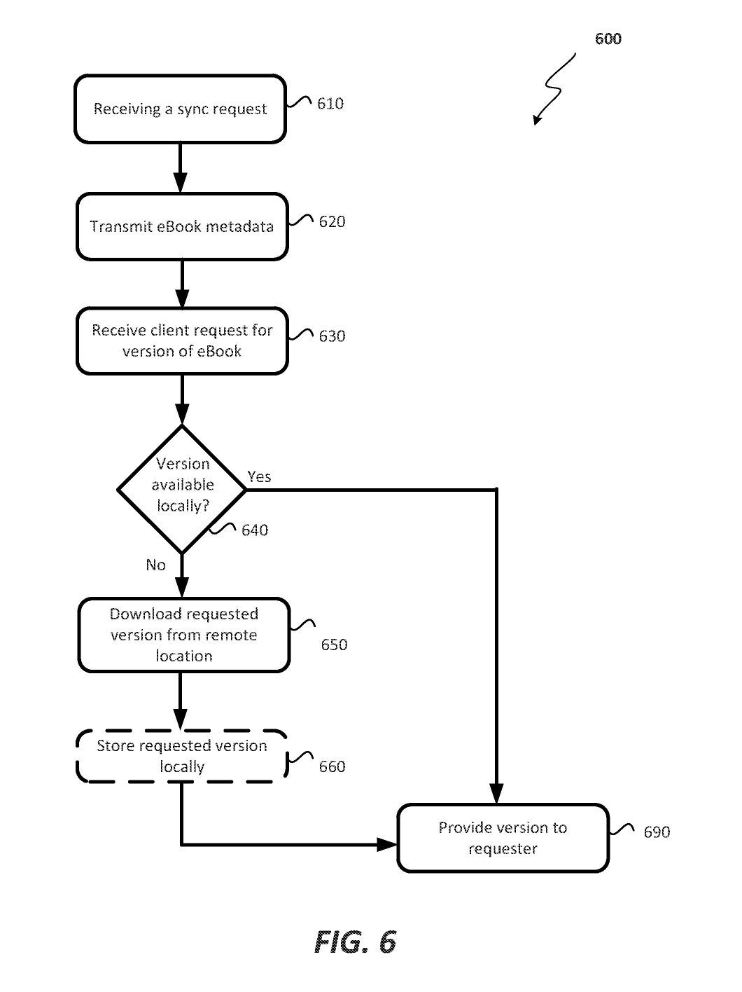

FIG. 6 illustrates an exemplary process for executing a sync request between two client devices. Process 600 can be stored in computer readable media and be executed by a processor. The processor can be part of a client device configured to deliver a rendition of an eBook to another client device during a sync process. In one example, the client device can be a desktop computer configured to distribute eBooks to other client devices. Some of the other client devices can be portable.

Process 600 can begin by receiving a sync request at 610. The sync request can be a request to synchronize digital assets with a client device. For example, a client computer can receive a sync request from a client portable device. Synchronization can include receiving eBooks or other digital assets from the client device. The digital assets received can be stored in a database. In one example, digital assets not currently available in the database can be transferred to the database. Synchronization can also include transferring eBooks or other digital assets to the client device. For example, digital assets can be retrieved from the database and transferred to the client device. In one embodiment, the sync request can include a request for an eBook. The request can include an identifier used to identify the eBook. In response to the request for the eBook, a rendition of the eBook available locally can be retrieved and metadata of the rendition can be transmitted to the client device at 620. The metadata can include information identifying the renditions of the eBook available locally. The metadata can also include information identifying the renditions of the eBook available locally and remotely.

After transmitting the eBook metadata, process 600 can continue by receiving a client request for a rendition of the eBook at 630. The client request can include an identifier to specify a rendition of the eBook. After receiving the client request, a determination is made whether the requested rendition is available locally at 640. If the rendition is available locally, the requested rendition is provided to the requester at 690. If the rendition is not available locally, process 600 can download the requested rendition from a remote location at 650. Once downloaded, process 600 can optionally store the downloaded rendition locally at 660. The downloaded rendition can subsequently be provided to the requester at 690.

### General System

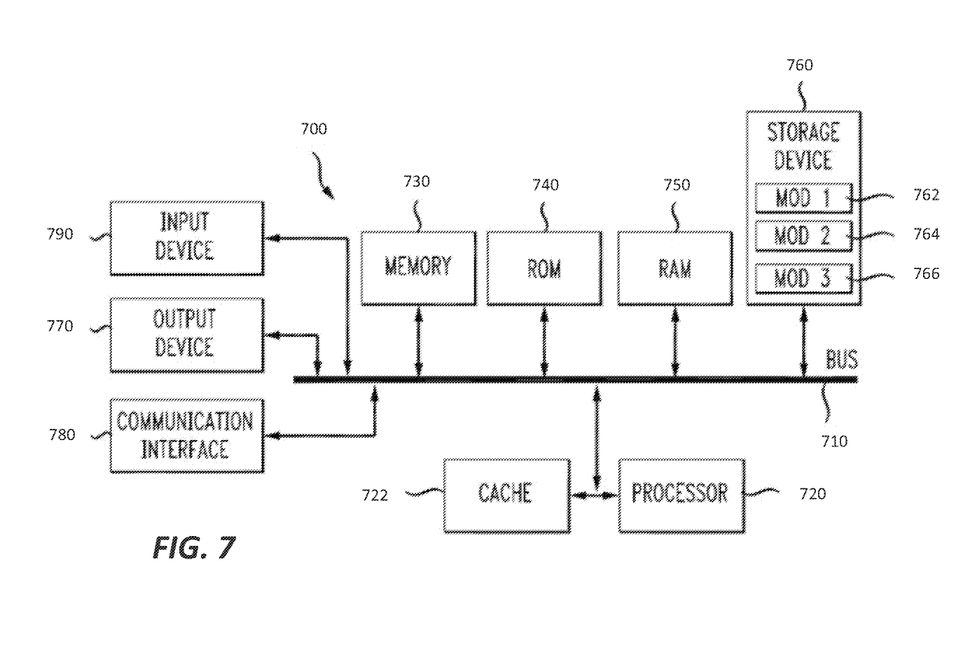

A general computing device can be configured to store and execute the media playback application. With reference to FIG. 7, an exemplary system 700 includes a general-purpose computing device 700, including a processing unit (CPU or processor) 720 and a system bus 710 that couples various system components including the system memory 730 such as read only memory (ROM) 740 and random access memory (RAM) 750 to the processor 720. The system 700 can include a cache 722 of high speed memory connected directly with, in close proximity to, or integrated as part of the processor 720. The system 700 copies data from the memory 730 and/or the storage device 760 to the cache 722 for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, a solid state drive, a tape drive or the like. The storage device 760 can include software modules 762, 764, 766 for controlling the processor 720. Other hardware or software modules are contemplated. The storage device 760 is connected to the system bus 710 by a drive interface. The drives and the associated computer readable storage media provide nonvolatile storage of computer readable instructions, data structures, program modules and other data for the computing device 700. In one aspect, a hardware module that performs a particular function includes the software component stored in a non-transitory computer-readable medium in connection with the necessary hardware components, such as the processor 720, bus 710, display 770, and so forth, to carry out the function. The basic components are known to those of skill in the art and appropriate variations are contemplated depending on the type of device, such as whether the device 700 is a small, handheld computing device, a desktop computer, or a computer server.

Although the exemplary embodiment described herein employs the hard disk 760, it should be appreciated by those skilled in the art that other types of computer readable media which can store data that are accessible by a computer, such as magnetic cassettes, flash memory cards, digital versatile disks, cartridges, random access memories (RAMs) 750, read only memory (ROM) 740, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks, including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general purpose processor. For example, the functions of one or more processors, presented in FIG. 7, may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 740 for storing software performing the operations discussed below, and random access memory (RAM) 750 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700, shown in FIG. 7, can practice all or part of the recited methods, can be a part of the recited systems, and/or can operate according to instructions in the recited non-transitory computer-readable storage media. Such logical operations can be implemented as modules configured to control the processor 720 to perform particular functions according to the programming of the module. For example, FIG. 7 illustrates three modules Mod1 762, Mod2 764 and Mod3 766 which are modules configured to control the processor 720. These modules may be stored on the storage device 760 and loaded into RAM 750 or memory 730 at runtime or may be stored, as would be known in the art, in other computer-readable memory locations. Having disclosed some components of a computing system, the disclosure now turns to a description of cloud computing.

### Cloud Computing System

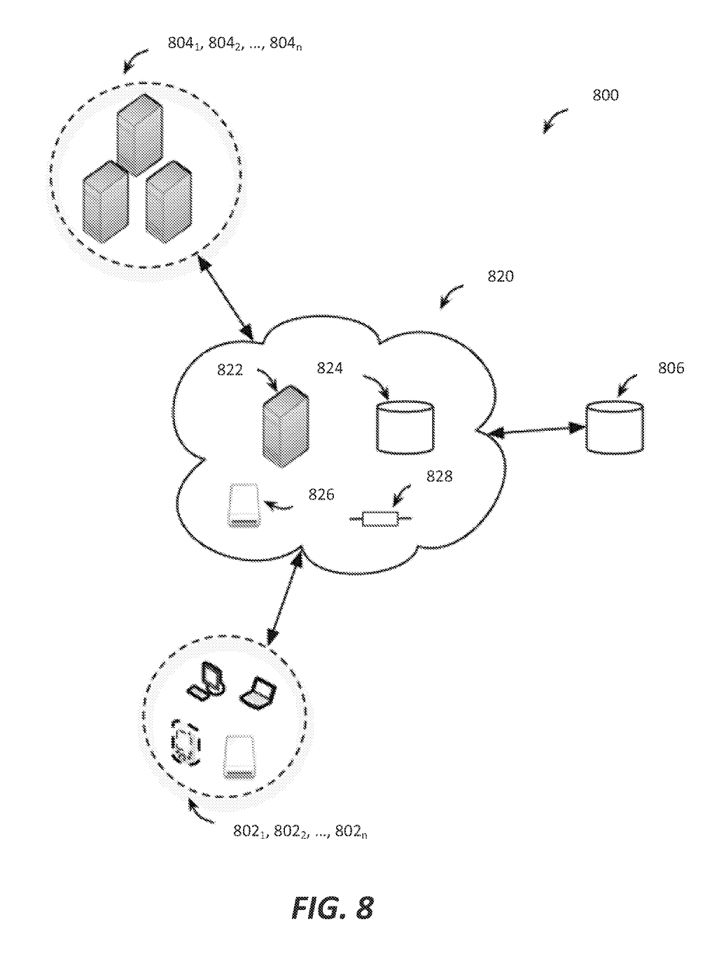

Cloud computing is a type of Internet-based computing in which a variety of resources are hosted and/or controlled by an entity and made available by the entity to authorized users via the Internet. An exemplary cloud computing system configuration 800 is illustrated in FIG. 8 wherein a variety of electronic devices can communicate via a network for purposes of exchanging content and other data. The system can be configured for use on a wide variety of network configurations that facilitate the intercommunication of electronic devices. For example, each of the components of system 800, in FIG. 8, can be implemented in a localized or distributed fashion in a network.

System 800 can be configured to include cloud computing resources 820 (i.e., “the cloud”). The cloud resources can include a variety of hardware and/or software resources, such as cloud servers 822, cloud databases 824, cloud storage 826, cloud networks 828, cloud applications, cloud platforms, and/or any other cloud-based resources. In some cases, the cloud resources are distributed. For example, cloud storage 826 can include multiple storage devices. In some cases, cloud resources can be distributed across multiple cloud computing systems and/or individual network enabled computing devices. For example, cloud computing resources 820 can communicate with servers 804₁, 804₂, . . . , 804ₙ (collectively “804”), database 806, and/or any other network enabled computing device to provide the cloud resources.

Furthermore, in some cases, the cloud resources can be redundant. For example, if cloud computing resources 820 is configured to provide data backup services, multiple copies of the data can be stored such that the data is still be available to the user even if a storage resource is offline, busy, or otherwise unavailable to process a request. In another example, if cloud computing resources 820 is configured to provide software, the software can be available from different cloud servers so that the software can be served from any of the different cloud servers. Algorithms can be applied such that the closest server or from the server with the lowest current load is selected to process a given request.

In system 800, a user interacts with cloud computing resources 820 through user terminals 802₁, 802₂, . . . , 802ₙ (collectively “802”) connected to a network by direct and/or indirect communication. Cloud computing resources 820 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices. Furthermore, cloud computing resources 820 can concurrently accept connections from and interact with multiple electronic devices. Interaction with the multiple electronic devices can be prioritized or occur simultaneously.

Cloud computing resources 820 can provide cloud resources through a variety of deployment models, such as public, private, community, hybrid, and/or any other cloud deployment model. In some cases, cloud computing resources 820 can support multiple deployment models. For example, cloud computing resources 820 can provide one set of resources through a public deployment model and another set of resources through a private deployment model.

In some configurations, a user terminal 802 can access cloud computing resources 820 from any location where an Internet connection is available. However, in other cases, cloud computing resources 820 can be configured to restrict access to certain resources such that a resource can only be accessed from certain locations. For example, if cloud computing resources 820 is configured to provide a resource using a private deployment model, then cloud computing resources 820 can restrict access to the resource, such as by requiring that a user terminal 802 access the resource from behind a firewall.

Cloud computing resources 820 can provide cloud resources to user terminals 802 through a variety of service models, such as Software as a Service (SaaS), Platforms as a service (PaaS), Infrastructure as a Service (IaaS), and/or any other cloud service models. In some cases, cloud computing resources 820 can provide multiple service models to a user terminal 802. For example, cloud computing resources 820 can provide both SaaS and IaaS to a user terminal 802. In some cases, cloud computing resources 820 can provide different service models to different user terminals 802. For example, cloud computing resources 820 can provide SaaS to user terminal 802₁ and PaaS to user terminal 802₂.

In some cases, cloud computing resources 820 can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources 820 such as servers 804 or database 806.

Cloud computing resources 820 can provide a variety of functionality that requires user interaction. Accordingly, a user interface (UI) can be provided for communicating with cloud computing resources 820 and/or performing tasks associated with the cloud resources. The UI can be accessed via an end user terminal 802 in communication with cloud computing resources 820. The UI can be configured to operate in a variety of client modes, including a fat client mode, a thin client mode, or a hybrid client mode, depending on the storage and processing capabilities of cloud computing resources 820 and/or the user terminal 802. Therefore, a UI can be implemented as a standalone application operating at the user terminal in one embodiment. In other embodiments, a web browser-based portal can be used to provide the UI. Any other configuration to access cloud computing resources 820 can also be used in the various embodiments.

As described above, in some configurations, the cloud computing resources can be used to store user data. The present disclosure contemplates that, in some instances, this gathered data might include personal and/or sensitive data. The present disclosure further contemplates that the entities responsible for the collection, analysis, disclosure, transfer, storage, or other use of such data should implement and consistently use privacy policies and practices that are, generally recognized, meeting or exceeding industry or governmental requirements for maintaining personal information data private and secure. For example, personal data from users should be collected for legitimate and reasonable uses of the entity and not shared or sold outside of those legitimate uses. Further, such collection should occur only after the informed consent of the users. Additionally, such entities should take any needed steps for safeguarding and securing access to such personal data and ensuring that others with access to the personal data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal data. That is, the present disclosure contemplates that hardware and/or software elements can be provided to prevent or block access to such personal data. For example, the present technology can be configured to allow users to select the data that is stored in cloud storage. In another example, the present technology can also be configured to allow a user to specify the data stored in cloud storage that can be shared with other users.

Therefore, although the present disclosure broadly covers use of personal data to implement one or more various disclosed embodiments, the present disclosure also contemplates that the various embodiments can also be implemented without the need for accessing such personal data. That is, the various embodiments of the present technology are not rendered inoperable due to the lack of all or a portion of such personal data. For example, non-personal data can be stored in cloud storage.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, solid state drives, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. The various embodiments described above are provided by way of illustration only and should not be construed to limit the scope of the disclosure. For example, the principles herein can be applied other types of files to control the secure deletion of those files and other copies of those files from storage. Those skilled in the art will readily recognize various modifications and changes that may be made to the principles described herein without following the example embodiments and applications illustrated and described herein, and without departing from the spirit and scope of the disclosure.

We claim:

1. A computer implemented method, comprising:
receiving, by a device, a request to sync an electronic book to a portable device;
transmitting, by the device, to the portable device, metadata associated with a rendition of the electronic book stored on the device before sending the electronic book; and
receiving, by the device, from the portable device, a request to receive a selected rendition of the electronic book, the request being based on the metadata.

2. The computer implemented method of claim 1, further comprising:
determining, by the device, that the selected rendition is unavailable locally; and
downloading the selected rendition of the electronic book from a remote location.

3. The computer implemented method of claim 1, further comprising:
determining, by the device, that the selected rendition is unavailable locally; and
instructing the client device to download the selected rendition of the electronic book from a remote location.

4. The computer implemented method of claim 1, wherein the metadata includes the resolution of a display which the rendition of the electronic book is optimized for.

5. The computer implemented method of claim 1, wherein the metadata includes an attribute of an image in the rendition of the electronic book.

6. The computer implemented method of claim 5, wherein the attribute describes the quality of the image.

7. The computer implemented method of claim 1, wherein the metadata identifies a plurality of available renditions of the electronic book.

8. The computer implemented method of claim 1, wherein at least one of the plurality of available renditions is unavailable locally.

9. The computer implemented method of claim 1, wherein the metadata includes an attribute of a video in the rendition of the electronic book.

10. The computer implemented method of claim 9, wherein the attribute is at least one of an encoding type, bit rate, and resolution of the video.

11. A computer implemented method, comprising:
receiving, at a server, from a client device, a request for an electronic book;
determining, by a processor, that the electronic book is available in at least two renditions, wherein a first rendition of the electronic book is comprised of a composite of assets at a high resolution and a second rendition of the electronic book is comprised of the same composite of assets but at least one of the assets is at a reduced resolution; and
providing, by the server, to the client device, at least two links, each link being configured to download a different rendition of the electronic book.

12. The computer implemented method of claim 11, further comprising:
receiving, at the server, from the client device, a selected link from the provided links; and
providing, from the server, to the client device, a rendition of the electronic book that is associated with the selected link.

13. The computer implemented method of claim 11, wherein the composite of assets includes a video sequence.

14. The computer implemented method of claim 11, further comprising providing the first rendition of the electronic book to the client device by default.

15. The computer implemented method of claim 11, wherein the electronic book is also available in a third rendition, the third rendition including a similar composite of assets but at least one asset is provided as a link configured to download the asset from a remote source.

16. The computer implemented method of claim 15, wherein processing the link includes downloading the image at a native resolution of the client device.

17. A computer implemented method, comprising:
receiving, at a server, from a publisher, an electronic book having media at a first resolution and metadata;
resizing, by a processor, the media to a second resolution according to the metadata;
generating, by the processor, a rendition of the electronic book, wherein the rendition includes the resized media; and
storing, at the server, the rendition of the electronic book.

18. The computer implemented method of claim 17, wherein the metadata includes a resolution of a display which the rendition of the electronic book is optimized for.

19. The computer implemented method of claim 17, wherein the metadata includes a desired pixels per inch value for the media.

20. The computer implemented method of claim 17, wherein the metadata is includes a thinning tag describing whether the electronic book has been reduced in size.

21. A non-transitory computer readable medium implemented method which, when executed by a computing device, causes the computing device to perform steps comprising:
receiving, by a device, a request to sync an electronic book to a portable device;
transmitting, by the device, to the portable device, metadata associated with a rendition of the electronic book stored on the device before sending the electronic book; and
receiving, by the device, from the portable device, a request to receive a selected rendition of the electronic book, the request being based on the metadata.
